(19) United States
(12) Patent Application Publication
(10) Pub. No.: US 2015/0318706 A1
(43) Pub. Date: Nov. 5, 2015

(54) Multi-source renewable energy station

(71) Applicants: Adrian ILINCA, Rimouski (CA); Jean-Louis CHAUMEL, Rimouski (CA)

(72) Inventors: Adrian ILINCA, Rimouski (CA); Jean-Louis CHAUMEL, Rimouski (CA)

(21) Appl. No.: 14/545,268

(22) Filed: Apr. 14, 2015

Related U.S. Application Data
(60) Provisional application No. 61/996,181, filed on May 1, 2014.

(51) Int. Cl. H02J 4/00; G05B 15/02

(52) U.S. Cl. CPC H02J 4/00; G05B 15/02

(57) ABSTRACT

The renewable energy station comprising: a housing containing a main central controller and an electrical power distribution center connected to this main central controller. The station comprises wind turbines solar panels, batteries, and a gas/diesel engine-generator. Loads are connected to the electrical power distribution center. The wind turbines and the solar panels are grouped into a plurality of generating cells wherein each generating cell comprises at least one wind turbine and at least one solar panel. The main central controller and the electrical distribution center jointly have switching and control equipment therein for selectively connecting and disconnecting each of the loads to and from the electrical power distribution center. Reactive-type loads are given priority over resistive-type loads. The heat from the gas/diesel engine-generator is used to melt snow and ice from the solar panels. Tandem connection of two stations is done via an inlet receptacle on each station.

The present patent application claims the benefit of U.S. Provisional Application No. 61/996,181, filed May 1, 2014.

### FIELD OF THE INVENTION

This invention pertains to renewable energy generators. More particularly, it pertains to systems for improving the efficiency of a renewable energy station.

### BACKGROUND OF THE INVENTION

Renewable energy is a natural option for providing electrical power to users in an off-grid environment. Working with renewable energy sources, however, is not free of risks and challenges. For example solar panels can become frosted or ice-covered in cold climate regions. Wind turbines are moving machines and need to be inspected and maintained. But most of all, renewable energy sources are intermittent and cannot be relied upon when the customer needs a stable and reliable electrical power supply.

The management of renewable energy sources requires relatively complex electronic equipment. The main challenge consists of reducing the risks of a power outage. This has been done in the past by using battery storage and by increasing the number of power generating sources. Ultimately a conventional diesel engine-generator is started to make up for any shortfall. In many cases, the “diesel-source generation” remains a significant portion of the total electrical power production, and the renewable energy systems serve no more than reducing the diesel fuel consumption.

Examples of renewable energy systems and associated controls, methods and equipment in the prior art can be found in the following documents:
U.S. Pat. No. 7,925,597 issued to T. Takano et al., on Apr. 12, 2011;
U.S. Pat. No. 8,536,720 issued to D. L. Bates et al., on Sep. 17, 2013;
U.S. Publication 2006/0119106, by R. B. Borden et al., on Jun. 8, 2006;
U.S. Publication 2006/0137348, by P. A. J. Pas, on Jun. 29, 2006;
U.S. Publication 2011/0049992, by Sant'Anselmo et al., on Mar. 3, 2011;
U.S. Publication 2011/0146751, by D. McGuire on Jun. 23, 2011;
CA Publication 2,793,408, by B. S. Hardin, on Sep. 22, 2011.

Although the inventions found in the prior art deserve undeniable merits, there continues to be a need for a control system and equipment to improve the efficiency of a renewable energy station. For example, there is a need to address the deicing of solar panels in colder regions. There is also a need to better prioritize the loads when energy generation is limited.

SUMMARY OF THE PRESENT INVENTION

In the present invention, there is provided a control system to use the heat generated by a gas/diesel engine-generator during a maintenance run for example, to remove ice formations on solar panels to increase the efficiency of the solar panels. Similarly, the renewable energy station according to the present invention has controls therein to prioritize on inductive, capacitive and essential loads during a shortage of available renewable power.

In a first aspect of the present invention, there is provided a renewable energy station for providing electrical power to a user in an off-grid environment, comprising: a housing containing a main central controller and an electrical power distribution center connected to this main central controller. The station has a plurality of wind turbines attached to the housing and connected to the main central controller and to the electrical power distribution center for generating wind-source electrical power and for making available this wind-source electrical power to the electrical power distribution center. There is also provided a plurality of solar panels attached to outside surfaces of the housing and connected to the main central controller and to the electrical power distribution center for generating solar-source electrical power and for making available this solar-source electrical power to the electrical power distribution center. A plurality of loads are connected to the electrical power distribution center. The wind turbines and the solar panels are grouped into a plurality of generating cells wherein each generating cell comprises at least one wind turbine and at least one solar panel. The main central controller and the electrical distribution center jointly have switching and control equipment therein for selectively connecting and disconnecting each of the generating cells to and from the electrical power distribution center and for connecting and disconnecting each of the loads to and from the electrical power distribution center.

Electrical power is extracted from the solar panel and from the wind turbine in each generating cell separately or together according to the respective real-time production potentials of these sources. Electrical power is extracted from each generating cell and is used primarily for charging the batteries of the station. However, power extracted from the generating cells can also be made available to the loads via the electrical power distribution center, when the batteries are fully charged up for example, and when the power available from the generating cell is compatible with the demand of the load.

Both the sources and the loads are segmented and managed independently in order to reduce the risk of a low voltage or total loss of power. As soon as a low performance is detected on a generating cell, non-essential loads are disconnected and another generating cell is put on line to avoid an outage that can be detrimental to the vocation of the station.

In another aspect of the present invention, there is provided a renewable energy station for providing electrical power to a user in an off-grid environment, comprising a housing containing a main central controller and an electrical power distribution center connected to the main central controller. A plurality of solar panels are attached to outside surfaces of the housing and connected to the main central controller and to the electrical power distribution center for generating solar-source electrical power and making that solar-source electrical power available to the electrical power distribution center. A plurality of loads are connected to the electrical power distribution center. There is also provided a gas/diesel engine-generator mounted in the housing and connected to the main central controller and to the electrical power distribution center for generating diesel-source electrical power and for making that diesel-source electrical power available to the electrical power distribution center during a shortfall of solar-source electrical power from the solar panels. The gas/diesel generator is enclosed inside a plenum, and a duct-work system is provided inside the housing for moving heat during winter from the gas/diesel engine-generator to spaces behind the solar panels to heat the solar panels and to melt snow and ice from the solar panels.

In yet another aspect of the present invention, there is provided a renewable energy station for providing electrical power to a user in an off-grid environment, comprising: a housing containing a main central controller and an electrical power distribution center connected to this main central controller. The station has a plurality of wind turbines attached to the housing and connected to the main central controller and to the electrical power distribution center for generating wind-source electrical power and for making available this wind-source electrical power to the electrical power distribution center. There is also provided a plurality of solar panels attached to outside surfaces of the housing and connected to the main central controller and to the electrical power distribution center for generating solar-source electrical power and for making available this solar-source electrical power to the electrical power distribution center. A plurality of loads are connected to the electrical power distribution center. The wind turbines and the solar panels are grouped into a plurality of generating cells wherein each generating cell comprises at least one wind turbine and at least one solar panel. Each load in the plurality of loads is assigned a priority value based on a type and on an essentiality of that load. The main central controller has a first memory therein for retaining the priority values of the loads and instrumentation for detecting reactive and resistive load types. The main central controller and the electrical power distribution center jointly have switching and control equipment therein for selectively connecting and disconnecting each of the loads to and from said electrical power distribution center, according to their priority values, load types, and power availability from the generating cells. Higher priority values are assigned to essential loads and to reactive-type loads.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

A preferred embodiment of the multi-source renewable energy station according to the present invention is described with the aid of the accompanying drawings, in which like numerals denote like parts throughout the several views:

FIG. 1 is a schematic representation of the elements included in the preferred multi-source renewable energy station and their relation with each other in the operation of the preferred energy station;

FIG. 2 is a perspective view of the preferred multi-source renewable energy station;

FIG. 3 is a partial view of the control equipment included in the preferred multi-source renewable energy station;

FIG. 4 is an elevation view of a power output bar included in the preferred multi-source renewable energy station;

FIG. 5 is a cross-sectional plan view of the preferred multi-source renewable energy station as seen along line 5-5 in FIG. 2;

FIG. 6 is a perspective view of a portion of the duct-work system included in the preferred multi-source renewable energy station.

The drawings presented herein are presented for convenience to explain the functions of all the elements includes in the preferred embodiment of the present invention. Elements and details that are obvious to the person skilled in the art may not have been illustrated. Conceptual sketches have been used to illustrate elements that would be readily understood in the light of the present disclosure. These drawings are not fabrication drawings, and should not be scaled.

### DESCRIPTION OF THE PREFERRED EMBODIMENT

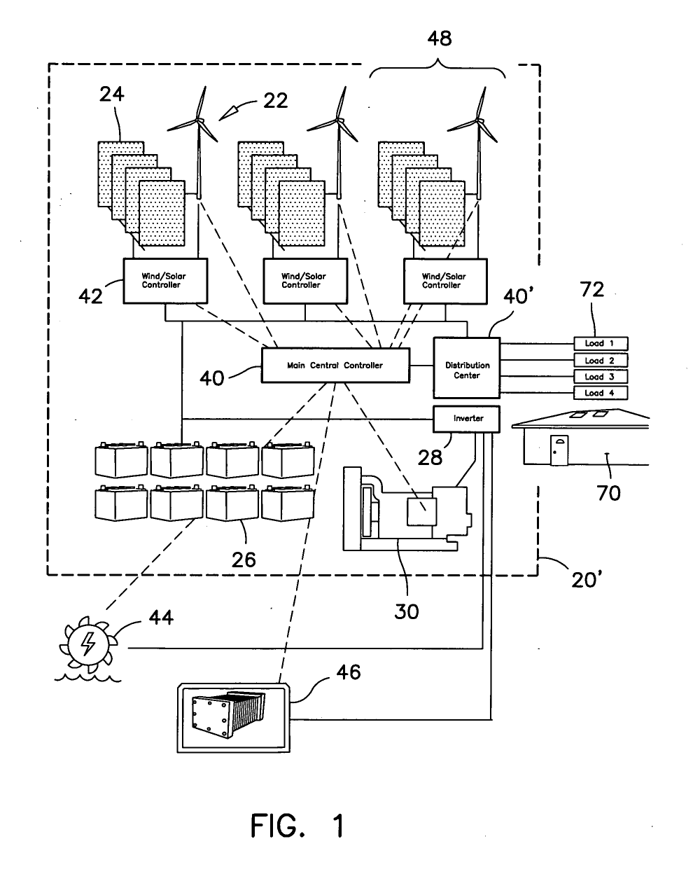

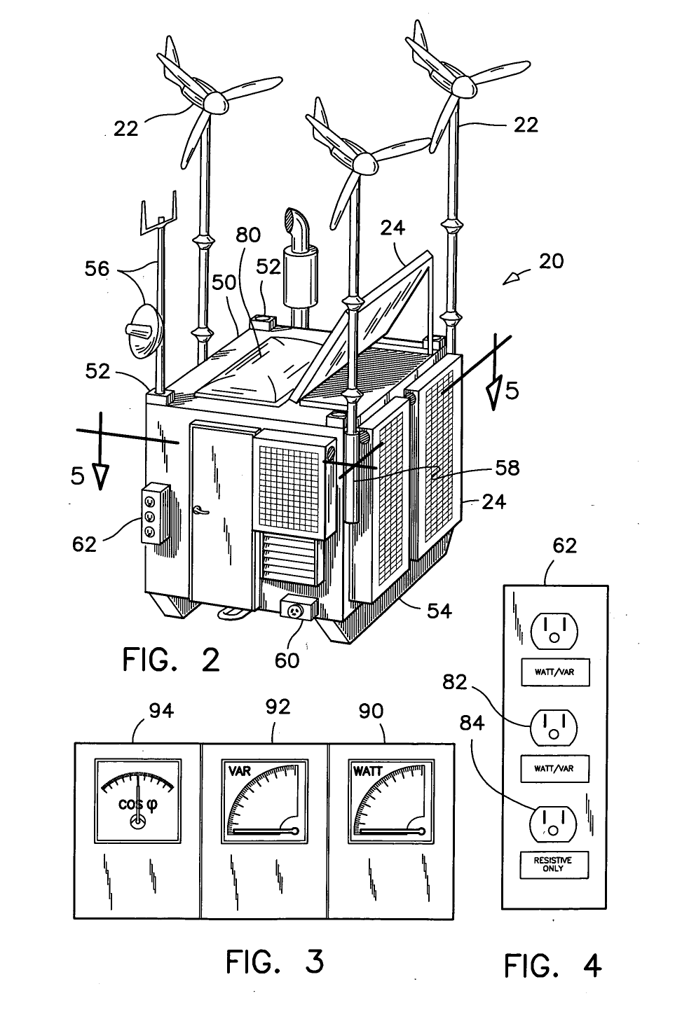

Referring firstly to FIGS. 1 and 2, there are disclosed therein the systems and devices related to the operation of the preferred multi-source renewable energy station, hereinafter also referred to as the preferred energy station 20. The preferred energy station 20 combines solar, wind and other renewable energy sources for generating electrical power and making available this electrical power to a user in an off-grid environment.

The preferred energy station 20 comprises a cubical enclosure 20′ for housing all electrical components and controls, and for providing a compact self-standing structure for supporting three wind turbines 22 and several solar panels 24. This preferred energy station 20 also includes electronic instrumentation, switching and controls equipment, a bank of batteries 26, converters 28, and a gas/diesel engine-generator 30, in order to generate stable electric power for reliable use in an off-grid environment. It will be appreciated that the expression off-grid environment means a region far from any conventional electrical power distribution network.

The control system comprises a main central controller 40 including a computer, and several electronics instruments which are dedicated to manage variable energy sources and electrical loads, in order to ensure autonomy and safety of the station.

The preferred energy station 20 also includes environment instrumentation (not shown) such as a wind speed meter, temperature meter, a light meter, a clock and an electronic calendar to be used in the decision making of its main central controller 40. Equally provided in the preferred energy station 20 are monitoring instruments (not shown) to record the performance of all its power generating elements. Furthermore, the main central controller 40 includes memories, a data processor and programmable logic controller (not shown) to determine in real time an expected power generation capacity of each of the power generating elements of the station 20 and to perform custodian actions such as managing the loads according to power generation.

The solar panels 24 are given a higher level of importance in the generation of electricity to supply the demand on the preferred energy station 20. The wind turbines 22 are considered next in importance and optional external renewable energy sources are considered third in importance. The batteries 26 are considered fourth in importance for supplying power to a load, because battery-source power is preferrably used when no power is available from the solar panels 24, from the wind turbines 22, or from an outside sources. The gas/diesel engine-generator 30 is considered a last resource. The gas/diesel engine-generator 30 generates diesel-source electrical power and makes this diesel-source electrical power available for distribution during a shortfall of electrical power from the wind turbines 22, the solar panels 24 and the batteries 26. Diesel-source electrical power is also used to charge up the batteries 26.

Solar and wind energy sources are integrated to each other using the wind-solar controller 42. These wind-solar controller 42 are converting AC, three-phase output power from the wind turbines 22 and DC current from solar panels 24 to appropriate DC voltage for charging the batteries 26.

The power generated by all sources of the preferred energy station 20 can be used for charging the batteries 26 or can be made available to a load through the electrical power distribution center 40′ connected to the main central controller 40. The electrical power distribution center 40′ preferably includes one or more AC/DC converter and/or DC/AC inverter to connect one of the generating cell directly to a load, when electrical power generated by that cell is suitable for that load and relatively steady. For example, low priority loads such as a light fixture, a ventilation fan, a water heater, a receptacle for powering entertainment equipment are preferably powered directly from a solar panel 24 without passing through the bank of batteries 26.

Wind/solar controllers 42 have instruments therein for controlling the operation and speed of the wind turbines 22 when the solar panels 24 cannot supply the demand. It will be appreciated that it is crucial to reduce wind turbine rotation or to stop the wind turbines 22 during storms. Without such a precise control, any wind turbine 22 can rapidly destroy itself in strong and gusty winds. Each wind/solar controller 42 is able to stop its associated wind turbine 22 or to reduce its speed/production, according to various programmed rules and protocols. In the same way, any other turbine or non-solar electrical source which could be linked to the main central controller 40, like a mini hydro turbine 44 or a fuel cell 46, can also be stopped and started when critical parameters are reached or when the operation of that machine is not required.

The main central controller 40 manages all the components included in and on the preferred energy station 20. This main central controller 40 also manages these systems when the preferred energy station 20 is connected in parallel to other renewable energy stations. Such a combination of energy stations connected in parallel requires that the main central controller 40 in each station is not disturbed by the others and that all power generators remain balanced, synchronized and properly regulated with each other and with their connected loads.

The main load of the preferred energy station 20 is divided in several independent load units or electrical appliances, thereby increasing the safety and reliability of the preferred energy station 20. This load segmentation is particularly advantageous when the preferred energy station 20 is located in a remote location with no supervision.

Each one of these load units is prioritized and individually controlled by the main central controller 40. Priority is assigned according to their importance and their essentiality. For examples, higher priority and essentiality are assigned to communication equipment and to the starter circuit of the gas/diesel engine-generator 30. A lower priority and essentiality are assigned to space heaters, light fixtures and similar non-essential loads. It will be appreciated that loads of a same priority are grouped together to a same circuit out of the electrical power distribution center 40′.

The main central controller 40 and its associated electrical power distribution center 40′ have switching and control equipment therein to disconnect any load at any time, according to priority of the loads and power generation. Balancing power production and electrical consumption with regard to energy reserve ensures that the preferred energy station 20 will not be shut down despite significant variations of wind or sun intensity.

Referring now to FIG. 2, the preferred energy station 20 is made of a cubical aluminum housing 50. This aluminum housing 50 serves multi-purposes because it is used as a packaging container for shipping and transporting all the equipment included in the preferred energy station 20. The cubical shape of the housing 50 is advantageous for transporting the preferred energy stations 20 by ship, by transport trailers or by other transportation means requiring optimization of available space.

The aluminum housing 50 also provides a self-standing structure to support the three wind turbines 22 and the solar panels 24. Weight and size of the housing 50 are designed to make easy its transportation by any type of vehicle. Four eye hooks 52 are also provided on the roof of the housing 50 making the housing 50 transportable by helicopter to locations with difficult access. Runners or skids 54 are also provided under the floor of the housing 50 for easily pulling the housing 50 as a sleigh or on ramps to or off an utility trailer.

The three wind turbines 22 are directly mounted to the housing 50 and the solar panels 24 are fixed to the external walls of the housing 50, and to the roof. A radio antenna 56 is also provided to send and receive communications messages to and from the preferred energy station 20.

The deployment of the preferred energy station 20 is fast due to the fact that most of the components which need to be attached to the housing 50 are “plug-an-play” type and do not need special tooling or lifting equipment during their installation. Telescoping masts of wind turbines are simply clipped to individual support brackets 58 and extended to desired heights. An electrical weatherproof inlet receptacle 60 is provided outside the housing 50 to connect the preferred energy station 20 in parallel with another preferred energy station 20. The inlet receptacle 60 is also used to connect an outside source of power such as a hydro-generator 44 or a fuel cell 46 to the preferred energy station 20. One or more electrical outlet bars 62 are mounted outside the housing 50 to allow fast connection of the preferred energy station 20 to a serviced building 70 as illustrated in FIG. 1, or to any other electrical equipment. It will be appreciated that the outlet power bar 62 is part of the distribution center 72 as illustrated in FIG. 1.

In order to improve efficiency of all the electric energy produced by the preferred energy station 20, the wind turbines 22 and solar panels 24 are grouped in three generating cells 48 as illustrated in FIG. 1. Each generating cell 48 is composed of one wind turbine 22 and several solar panels 24.

The three wind-solar generating cells 48, the bank of batteries 26 and the gas/diesel engine-generator 30, are being continuously monitored by the main central controller 40. The main central controller 40 modulates the production from these energy groups according to two factors: the battery charge and the power required or anticipated by the loads.

In case of excess power, the main central controller 40 can stop or reduce power generation from any of the aforesaid generating cells 48, and any other power source. Anticipated or planned consumption cycles or loads can be programmed in the main central controller 40 and power source modulation is applied. The main central controller 40 also manages the energy sources according to various running tests and preventive maintance tasks to be performed regularly. For example, the main central controller 40 starts and stops the gas/diesel engine-generator 30 at periodic intervals to ensure that this gas/diesel engine-generator 30 is in good working order and will readily start when needed, should an emergency occur.

The main central controller 40 is connected to the load distribution center 40′. The available energy distribution of the preferred energy station 20 consists in several electrical load systems 72 grouped in sections. This electrical distribution configuration allows the main central controller 40 to manage via the electrical power distribution center 40′, not only the electrical production but also the consumption. Because one inherent characteristic of renewable energy is its variability, the main central controller 40 connects or disconnects loads 72 via the electrical power distribution center 40′, based on priority level of the loads 72 and energy production in order to reach an optimum balance between power generation capacity and loads.

More specifically, the main central controller 40 has a first memory for storing an importance value for each of the wind turbines 22, each of the solar panels 24; each of the generation cells 48; the batteries 26 and for the gas/diesel engine-generator 30. The aforesaid switching and control equipment has allocation equipment therein for sequentially operating the solar panels 24; the wind turbines 22; the distribution cells 48; to draw power from the batteries 26; and to start the gas/diesel engine-generator 30 according to the load demand and their respective importance values.

The main central controller also has a second memory for storing a priority value for each of the loads. The aforesaid switching and control equipment also has selection equipment therein for supplying electrical power to the appropriate loads according to their priority values.

The main central controller 40 balances available power with the load in real time. Because multiple energy sources can be supplying multiple loads, the management of the entire electrical generation-load system is fast and accurate. Furthermore such a system is not only an efficient way to manage renewable energy, but also offers the capacity to manage failures or problems on the generation side of the system. For example, a damaged wind turbine 22 in one generating cell 48 is quickly detected and the high priority loads connected to that generating cell 48 are reallocated to another generating cell 48.

In order to use of the gas/diesel engine-generator 30 during emergencies only, the main central controller 40 takes preventive actions to delay any decision to start the gas/diesel engine-generator 30. Some loads 72 which are not considered essential, are disconnected by the main central controller 40 for a limited period of time, and reconnected as soon as the proper level of power is recovered. The main central controller 40 also intentionally delays the electrical supply to some loads that could operate periodically and wait favorable conditions (good winds for example) to reconnect and supply power to these specific loads.

In another aspect of the present invention, the present multi-source renewable energy station 20 contains structural incentives to connect reactive-type loads thereto as opposed to resistive loads. The renewable energy station 20 has monitoring equipment for distinguishing resistive-type loads and reactive-type loads, and for informing a user of the station when a connection to a resistive-type load is detected.

It is believed that modem solar panels 24 and wind turbines 22 are high efficiency devices that can be considered as smart sources of power. It is believed that the electric power obtained from these devices should be used wisely to produce elegant work.

It is believed that the use of a solar panel 24 to energize an electric space heater for example is a senseless way to use the energy generated. Heat can be obtained more efficiently directly from the sun using lens and reflectors for examples. The same philosophy applies to light fixtures. It makes more sense to install a window in a building and encourage daytime activities as opposed to energizing a light fixture with energy coming from a solar panel 24 or a wind turbine 22.

For these reasons, basically, it is believed that pure resistive loads are primitive loads, and their connection to a renewable energy source is a senseless way to consume that elegant energy.

Instrumentation, computers, motors, communication devices, rectifiers and controllers on the other hand, are relatively more intellectually-advanced and smarter elements. These devices contain capacitors, transistors and inductors that have the ability to modify and amplify electrical signals, and motors that can change an electrical current into mechanical work.

Therefore, it makes more sense to use solar power to operate a radio receiver/transmitter in a remote location, or to rotate an antenna to pick up a signal from a satellite, for example.

Instrumentation, computers, motors, communication devices, rectifiers and controllers represent capacitive and inductive loads generally, generating a certain amount of reactive power. Although additional capacitors and inductors may be needed to correct the power factor of a generating station, these loads make more sense in a renewable energy station.

A certain number of structural incentives are included in the preferred energy station 20 to encourage the use of the station for operating reactive-type, smarter loads.

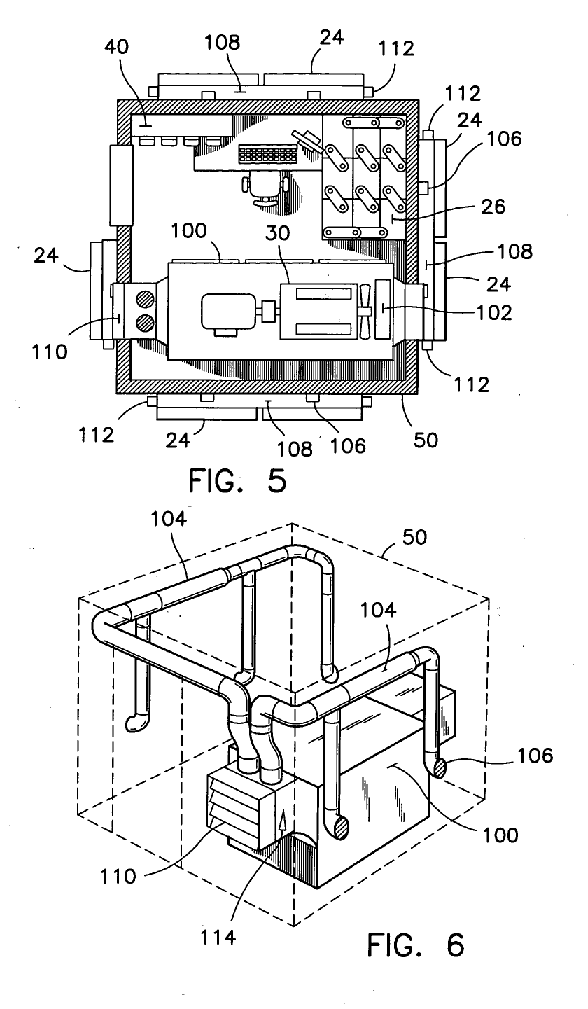

Referring now to FIGS. 2-5, some of the structural incentives to encourage the use of the preferred energy station 20 to operate reactive-type loads will be described.

Firstly, the preferred energy station 20 has a window 80 on its roof to let natural light shine inside the station and to obviate the need for resistive-type light fixture inside the station.

Referring to FIG. 4, the bank 62 of outlet receptacles includes one or more receptacles 82 identified as “Watt & Var” loads; and one receptacle 84 identified as “Resistive Only” load. In order to further encourage smart loads on the preferred energy station 20, the “Resistive Only” receptacle 84 is powered only when the diesel engine-generator 30 is operating.

Preferably, the instrumentation inside the preferred energy station 20 includes a watt meter 90, a var meter 92, and a power factor meter 94. When a load being connected to the station has a power factor that is not fluctuating from unity, a signal in the form of a warning light (not shown) or a visual LED display, is turned on to inform the user that such a resistive load on the preferred energy station 20 is not recommended.

Other signage and structural incentives are preferably used inside and outside the preferred energy station 20 to educate users and to promote the use of smart loads to maximize the production of elegant work with the energy generated by the preferred energy station 20.

In another aspect of the preferred energy station 20, ice formation on the solar panels 24 are removed by heat of the gas/diesel engine-generator 30 to obviate the need to spend valuable power from the batteries 26 in a resistive-type load.

The main central controller 40 has a third memory therein for storing preventive maintenance schedules for the wind turbines 22 and for the gas/diesel engine-generator 30. The switching and control equipment of the station comprises relays for selectively operating the generation cells 48 and the gas/diesel engine-generator 30 according to the preventive maintenance schedules so that all mechanisms in these devices remain lubricated and in good running order.

The gas/diesel engine-generator 30 is preferably enclosed in a plenum 100 to receive warm air from its radiator 102 and engine block, and to convey this warm air, by the fan of the engine, through a duct-work system 104 and into outlet openings 106 located in spaces behind each solar panel 24.

The gas/diesel engine-generator 30 is operated at prescribed time intervals, as a preventive measure to ensure reliability and to circulate lubricant therein. The running time of these preventive maintenance routines is sufficiently long to warm up the engine. The heat generated during these periods is carried into spaces 108 behind the solar panels 24, to heat the solar panels 24 and to dislodge any ice formation on the solar panels 24. When a low performance is detected in the solar panels 24, the gas/diesel engine-generator 30 is started and operated for a period of time sufficiently long to remove any ice formation on the solar panels 24 and to recover an expected performance from the solar panels 24. Due to this plenum 100 over the gas/diesel engine-generator 30, there is no need for any resistance heater to remove ice from the solar panels 24.

Normally, the warm air from the gas/diesel engine-generator 30 is exhausted from the plenum 100 through an openable louver window 110, and a fan 114 (not shown) that is mounted behind the louver window 110. During winter, the louver window 110 is closed and the warm air is directed into the duct-work system 104, and blown by the fan 114 into the spaces 108 behind the solar panels 24 and out through vents 112 at the top of these spaces 108.

It will be appreciated, that when a preventive maintenance test run is not yet scheduled on the gas/diesel engine-generator 30, and the solar panels 24 are operating at a low performance, the solar panel request takes precedence over the preventive maintenance schedule of the gas/diesel engine-generator 30. The gas/diesel engine-generator 30 is started to heat the solar panels 24 and to dislodge the ice formation on the panels 24. The preventive maintenance schedule for the gas/diesel engine-generator 30 is then readjusted accordingly.

While one embodiment of the present invention has been illustrated in the accompanying drawings and described herein above, it will be appreciated by those skilled in the art that various modifications, alternmate constructions and equivalents may be employed. Therefore, the above description and illustrations should not be construed as limiting the scope of the invention, which is defined in the appended claims.

What is claimed is:

1. A renewable energy station for providing electrical power to a user in an off-grid environment, comprising:
a housing containing a main central controller and an electrical power distribution center connected to said main central controller;
a plurality of wind turbines attached to said housing and connected to said main central controller and to said electrical power distribution center for generating wind-source electrical power and for making available said wind-source electrical power to said electrical power distribution center;
a plurality of solar panels attached to outside surfaces of said housing and connected to said main central controller and to said electrical power distribution center for generating solar-source electrical power and for making available said solar-source electrical power to said electrical power distribution center;
a plurality of loads connected to said electrical power distribution center;
said wind turbines and said solar panels being grouped into a plurality of generating cells wherein each of said generating cells comprises at least one of said wind turbines and at least one of said solar panels;
said main central controller and said electrical distribution center jointly having switching and control equipment therein for connecting and disconnecting each of said generating cells to and from the electrical power distribution center and for connecting and disconnecting each of said loads to and from said electrical power distribution center.

2. The renewable energy station as claimed in claim 1, wherein said housing is made of aluminium and has a cubical shape.

3. The renewable energy station as claimed in claim 1, further comprising a plurality of batteries in said housing for storing power generated by said wind turbines and said solar. panels.

4. The renewable energy station as claimed in claim 3 further comprising a gas/diesel engine-generator in said housing; said gas/diesel engine-generator being connected to said main central controller and to said electrical power distribution center for generating diesel-source electrical power and for making said diesel-source electrical power available to said electrical power distribution center during a shortfall of electrical power from said wind turbines, said solar panels and said batteries.

5. The renewable energy station as claimed in claim 1, wherein said housing comprises a window on a roof thereof.

6. The renewable energy station as claimed in claim 1, wherein said housing comprises skids under a floor thereof.

7. The renewable energy station as claimed in claim 6, wherein said housing comprises lifting hooks on a roof thereof.

8. The renewable energy station as claimed in claim 1, further comprising telescoping masts supporting said wind turbines to said housing.

9. The renewable energy station as claimed in claim 4, further including an inlet receptacle on an outside wall of said housing; said inlet receptacle being connected to said main central controller and to said electrical power distribution center for connection of an outside source of electrical power to said electrical power distribution center.

10. The renewable energy station as claimed in claim 4, wherein said main central controller has a first memory therein for storing an importance value of each of said wind turbines, said solar panels; each of said generating cells; said plurality of batteries and said gas/diesel engine-generator; and said switching and control equipment having allocating equipment therein for sequentially operating said wind turbines, said solar panels; said generating cells; and said gas/diesel engine-generator according to said importance values and to an electrical power demand on said electrical power distribution center.

11. The renewable energy station as claimed in claim 10, wherein said main central controller has a second memory therein for storing a priority value for each of said loads, and said switching and control equipment has selection equipment therein for supplying electrical power to said loads according to said priority values.

12. The renewable energy station as claimed in claim 11, wherein said switching and control equipment comprises monitoring equipment for distinguishing between resistive-type loads and reactive-type loads, and for informing said user of a connection thereto a resistive-type load.

13. The renewable energy station as claimed in claim 11, wherein said main central controller has a third memory therein for storing preventive maintenance schedules for said wind turbines and said gas/diesel engine-generator, and said switching and control equipment comprising relays therein for selectively operating said generation cells and said gas/diesel engine-generator according to said preventive maintenance schedules.

14. A renewable energy station for providing electrical power to a user in an off-grid environment, comprising:
a housing containing a main central controller and an electrical power distribution center connected to said main central controller;
a plurality of solar panels attached to outside surfaces of said housing and connected to said main central controller and to said electrical power distribution center for generating solar-source electrical power and making said solar-source electrical power available to said electrical power distribution center;
a plurality of loads connected to said electrical power distribution center; and
a gas/diesel engine-generator mounted in said housing and connected to said main central controller and to said electrical power distribution center for generating diesel-source electrical power and for making said diesel-source electrical power available to said electrical power distribution center during a shortfall of said solar-source electrical power from said solar panels;
said gas/diesel generator being enclosed inside a plenum, and said housing further including a duct-work system for moving heat from said gas/diesel engine-generator to spaces behind said solar panels to heat said solar panels and to melt snow and ice from said solar panels.

15. The renewable energy station as claimed in claim 14, wherein said main central controller includes: a memory of a preventive maintenance schedule relative to said gas/diesel engine-generator; performance monitoring equipment connected to said solar panels, and relays therein for starting said gas/diesel engine-generator during winter when a performance on said solar panels is low, and for updating said preventive maintenance schedule.

16. A renewable energy station for providing electrical power to a user in an off-grid environment, comprising:
a housing containing a main central controller and an electrical power distribution center connected to said main central controller;
a plurality of wind turbines attached to said housing and connected to said main central controller and to said electrical power distribution center for generating wind-source electrical power and for making available said wind-source electrical power to said electrical power distribution center;
a plurality of solar panels attached to outside surfaces of said housing and connected to said main central controller and to said electrical power distribution center for generating solar-source electrical power and for making available said solar-source electrical power to said electrical power distribution center;
a plurality of loads connected to said electrical power distribution center; each of said loads being assigned a priority value based on a load type and an essentiality of said load;
said wind turbines and said solar panels being grouped into a plurality of generating cells wherein each of said generating cells comprises at least one of said wind turbines and at least one of said solar panels;
said main central controller having a first memory for retaining said priority values of said loads and said main central controller and said electrical power distribution center jointly having switching and control equipment therein for connecting and disconnecting each of said loads to and from said electrical power distribution center according to said priority values, said load type and power availability from said generating cells.

17. The renewable energy station as claimed in claim 16, further including signage therein for encouraging a connection of reactive-type loads to said electrical power distribution center.

18. The renewable energy station as claimed in claim 17, further including:
a gas/diesel engine-generator mounted in said housing and connected to said main central controller and to said electrical power distribution center for generating diesel-source electrical power and for making said diesel-source electrical power available to said electrical power distribution center and to one of said loads during a shortfall of said wind-source electrical power from said wind turbines and said solar-source electrical power from said solar panels; and
an electrical power receptacle dedicated to resistive-type loads, and said switching and control equipment comprising a relay therein for selectively energizing said electrical power receptacle only when said gas-diesel engine-generator is operating.

19. The renewable energy station as claimed in claim 18, further including a power factor meter, and said switching and control equipment comprises a flashing light and signage for warning users of a resistive-type load being connected thereto, when a power factor of said load is not fluctuating from unity.

20. The renewable energy station as claimed in claim 18, wherein said gas/diesel engine-generator being enclosed inside a plenum, and said housing further including a duct-work system for moving heat from said gas/diesel engine-generator to spaces behind said solar panels to heat said solar panels and to melt snow and ice from said solar panels.
